(19) United States
(12) Patent Application Publication
(10) Pub. No.: US 2014/0159448 A1
(43) Pub. Date: Jun. 12, 2014

(54) CHILD SEAT SAFETY STRAP

(71) Applicant: PPA Solutions, LLC, Sanford, NC (US)

(72) Inventor: Jamie E. Williams, Carthage, NC (US)

(21) Appl. No.: 13/916,228

(22) Filed: Jun. 12, 2013

Related U.S. Application Data
(60) Provisional application No. 61/797,566, filed on Dec. 11, 2012.

(51) Int. Cl. B60N 2/28

(52) U.S. Cl. CPC B60N 2/28
USPC 297/250.1

(57) ABSTRACT

The invention relates to a tie-down system for a child safety seat wherein the child safety seat is held in place in a motor vehicle and tightened in place by use of web strapping with a ratcheting tightening device to hold down the child safety seat.

This application claims priority of U.S. provisional application No. 61/797,566 filed on Dec. 11, 2012 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a system and device for use with a child safety seat. In particular, it relates to a strap for use with a child safety seat as a total system for child seating in a motor vehicle.

2. Description of Related Art

The use of certain types of seat belts is required by most states and young children are strapped into a safety seat that is somehow mounted in the backseat of a motor vehicle. There are accommodations for attaching the child seat for the car seat. Those rings or the like are designed for attaching a strap to the car seat using standard seatbelt technology.

One problem with the present attachment of car seats to a motor vehicle back seat is doing a thorough job of tightening any strap to the attachment rings. It is often difficult to do, leaving the car seat attached but loose thus risking a serious injury if there is a motor vehicle accident; other devices hold the seat down but get in the way of the child or could be hit by a door. An inexpensive but effective method is still needed for tightening a car seat to a motor vehicle back seat.

### BRIEF SUMMARY OF THE INVENTION

The present invention relates to the discovery that a ratcheting webbing belt used to hold down a child car seat by clipping to the motor vehicle car seat clips and threading it behind the child in the car seat, works better and is easier to hold down the seat and does a better job of holding it in place than anything used since the availability of child car seats.

Accordingly, in one embodiment the present invention relates to a system for a child motor vehicle seat consisting essentially of:
a) a motor vehicle having a pair of attachment loops for a child car seat;
b) a child car seat having an attachment area for attaching the child car seat with one or more strap behind the child; and
c) a webbing strap having an attachment clip at each end for attaching to the attachment loops of the motor vehicle and a ratchet mechanism for adjusting the length of the strap when attaching the seat to the motor vehicle.

### BRIEF DESCRIPTION OF THE DRAWINGS

FIG. 1 is a perspective view of the belt of the present system

FIG. 2 is a perspective view of the belt hooked into a motor vehicle loop and a child seat loop behind the child.

FIG. 3 is a perspective view of a child car seat installed in a motor vehicle back seat with the belt of the present system.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “child motor vehicle seat” refers to a child car seat which is designed to be held in place with seat belts or some other strap design. They have an attachment area for threading a strap through the car sear usually through the back but there are many designs available but all have the threading behind the child. One skilled in the art can easily determine if a child car seat has attachment areas such as loops, holes and the like that are behind the child.

As used herein the term “motor vehicle” refers to those motor vehicles adapted to receive a child car seat and have a pair of attachment loops built into the motor vehicle in the crease between the motor vehicle seat and back (usually the back seat of a motor vehicle. This does not refer to the seat belts or any device other than those attachment devices specifically designed for attaching child seats.

As used herein the term “webbing strap” refers to standard nylon or other plastic or fiber strapping material normally used in motor vehicles for seat belts and tie down devices. The webbing strap can be a single piece or two pieces connected by the ratchet mechanism. At each end there is an attachment clip for attaching to the car seat attachment area. Press clips or other typed of locking hooks or the like are intended especially as shown in the figures.

As used herein the term “ratchet mechanism” refers to a ratchet device suitable for tightening a webbing strap or two pieces of webbing strap with a mechanishm that shortens the length or distance between the ends. Such tie downs are used in the industry and well know for cargo but never used or contemplated in car seats, likely because children are not considered cargo.

The webbing is then run through the child seat behind the child through the attachment area and attached to the attachment loops in the seat. The ratcheting mechanism is then used to tighten the strap till it is tight and the car seat does not move.

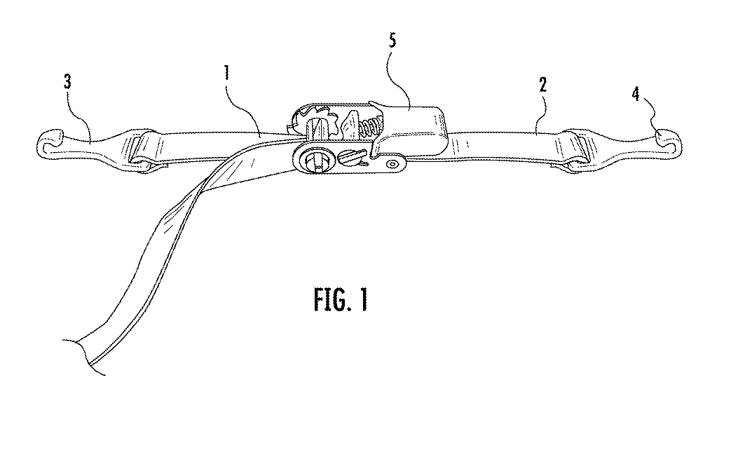

Now referring to the drawings FIG. 1 is a perspective view of the belt of the present system. A first web strap 1 and second web strap 2 each with clips 3 and 4 are shown connected with a ratchet mechanism 5 to form a single webbing strap of the present invention

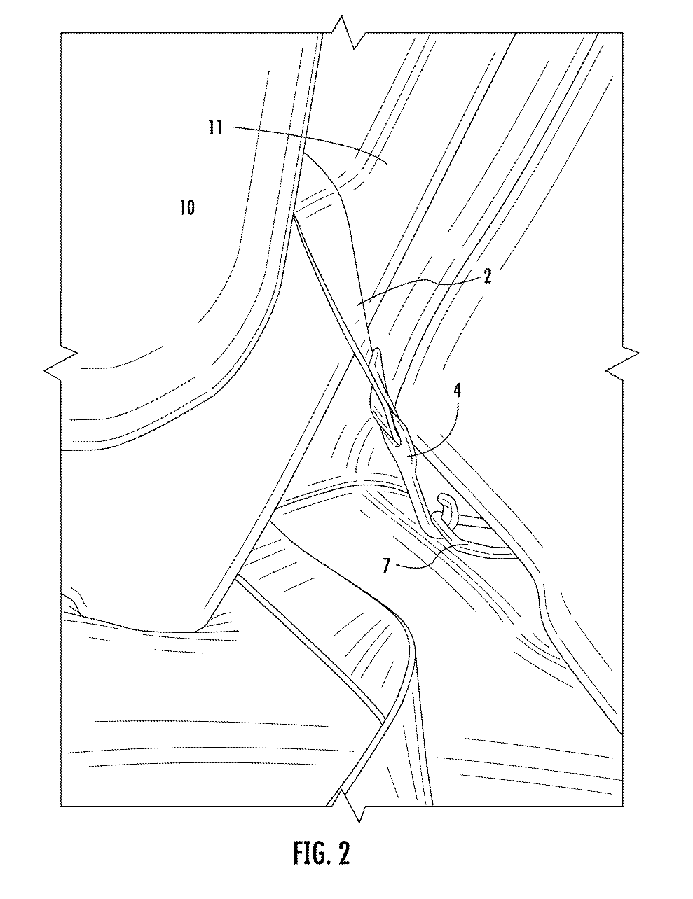

FIG. 2 is a perspective view of the belt hooked into a motor vehicle loop and a child seat loop behind where a child would sit. This shows clip 4 attached to car seat attachment loop 7. The webbing 2 is run through car seat 10 attachment area 11. This drawing shows one side attachment. The strap is run entirely through the child seat behind the child and the attachment duplicated on the opposite side.

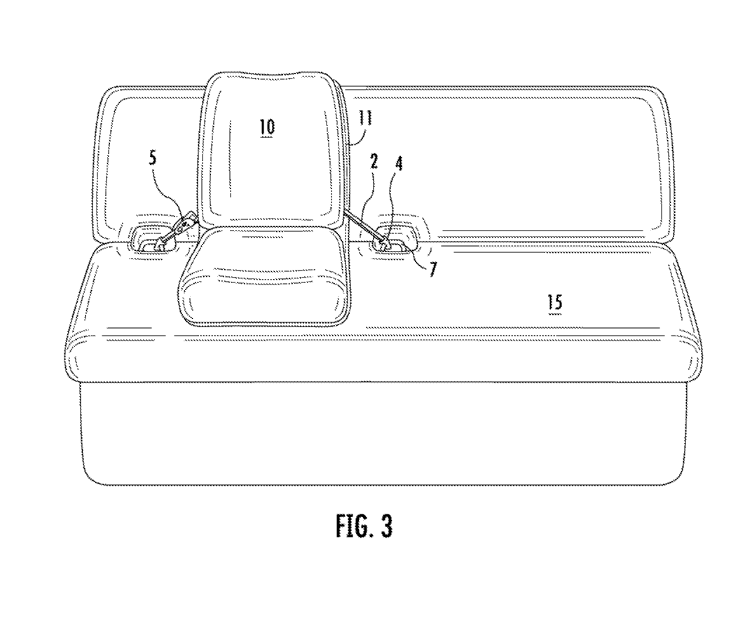

FIG. 3 is a perspective view of a child car seat installed in a motor vehicle back seat with the belt of the present system. Car seat 15 shown with the entire child car seat 10 is shown in place. The web strap is threaded through on both sides ath the ratchet 5 is used to cinch or tighten the entire system down.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for a child motor vehicle seat consisting essentially of:
a) a motor vehicle having a pair of attachment loops for a child car seat;
b) a child car seat having an attachment area for attaching the child car seat with one or more strap behind the child; and
c) a webbing strap having an attachment clip at each end for attaching to the attachment loops of the motor vehicle and a ratchet mechanism for adjusting the length of the strap when attaching the seat to the motor vehicle.

2. The system according to claim 1 wherein the webbing strap has two pieces of webbing attached together with the ratchet mechanism.

3. The system according to claim 1 wherein the child seat is attached to the motor vehicle with the webbing strap.
